(19) United States
(12) Patent Application Publication
(10) Pub. No.: US 2026/0223848 A1
(43) Pub. Date: Aug. 6, 2026

(54) METHOD OF INCREASING SUGAR PRODUCTION FROM SUGARCANE

(71) Applicant: CORTEVA AGRISCIENCE LLC, INDIANAPOLIS, IN (US)

(72) Inventors: LUIS ANTONIO PAVAN, MOGI MIRIM (BR); LUCAS PERIM, JARDINÓPOLIS (BR); CAIO VITAGLIANO SANTI ROSSI, UBERLANDIA (BR)

(73) Assignee: CORTEVA AGRISCIENCE LLC, INDIANAPOLIS, IN (US)

(21) Appl. No.: 18/554,691

(22) PCT Filed: Apr. 13, 2022
(86) PCT No.: PCT/US2022/024523

§ 371 Date: Oct. 10, 2023

Related U.S. Application Data
(60) Provisional application No. 63/175,646, filed on Apr. 16, 2021.

(51) Int. Cl. A01N 43/40; A01N 37/42; A01N 43/54; A01N 47/36; A01N 57/20; A01P 21/00

(52) U.S. Cl. CPC A01N 43/40; A01N 37/42; A01N 43/54; A01N 47/36; A01N 57/20; A01P 21/00

(57) ABSTRACT

Florpyrauxifen, halauxifen, haloxyfop-P, and agriculturally acceptable salts or esters thereof, and mixtures thereof, enhance total sugar recovery from sugarcane when applied to a sugarcane crop from about 30 to about 90 days prior to harvest.

### PRIORITY

This application claims priority to U.S. provisional application 63/175,646 filed on Apr. 16, 2021, which is hereby incorporated by reference in its entirety.

### BACKGROUND

Sugarcane is an important crop, for example, because of its many uses including the production of molasses, brown sugar, sugar, ethanol, and alcoholic beverages. Sugarcane is also useful for animal feed and sugar waste may be converted to fertilizer and fuel.

A supply of high-quality raw material is a continuing present need of the sugarcane industry. High-quality raw material, having high total recoverable sugar content is needed for economic extraction of raw sugar materials. Slowing sugarcane growth, allowing the plants to accumulate more sucrose, often happens during ripening and can be encouraged through the use of ripeners.

Several commonly used sugarcane ripeners are available for use in the market including ethephon, glyphosate, trinexapac and sulfometuron. Active sugarcane ripeners may differ widely from one another in chemical structure, properties, and biological activity. For example, see U.S. Pat. Nos. 3,224,865; 3,245,775; 3,291,592; 3,989,505; and United States Patent Application Publication Nos.: 20080261813; and 201002100467.

While some effective ripeners are known, there is an ongoing need for new sugarcane ripeners with improved toxicological and ecological properties. In addition, there is need for new sugarcane ripeners to better allow for the rotation of chemical ripeners from season to season. Ripener rotation may be preferable to continued use of a single ripener season after season.

### SUMMARY

It has been found that the herbicides fluorpyrauxifen, halauxifen, haloxyfop-P, and mixtures thereof, and agriculturally acceptable salts and esters thereof, are effective sugarcane ripeners at low use rates when applied 30 to 90 days before harvest.

Certain aspects provided herein include methods for ripening a sugarcane crop which comprises applying an effective amount of florpyrauxifen, or an agriculturally acceptable salt or ester thereof to the crop between 30 and 90 days prior to harvest. A preferred ester of florpyrauxifen is florpyrauxifen-benzyl.

Some aspects herein include a method for ripening a sugarcane crop which comprises applying an effective amount of florpyrauxifen plus haloxyfop-P, and agriculturally acceptable salts or esters thereof, to the crop between 30 and 90 days prior to harvest.

In some aspects, various methods for ripening a sugarcane crop may include applying an effective amount of halauxifen, or an agriculturally acceptable salt or ester thereof, to the crop between 30 and 90 days prior to harvest. In various aspects, a preferred ester of halauxifen may be halauxifen-methyl.

Some aspects include methods for ripening a sugarcane crop which comprises applying an effective amount of halauxifen, or an agriculturally acceptable salt or ester thereof, plus an effective amount of haloxyfop-P, or an agriculturally acceptable salt or ester thereof, to the crop between 30 and 90 days prior to harvest.

Some aspects disclosed herein include methods for ripening a sugarcane crop which comprises applying an effective amount of haloxyfop-P, or an agriculturally acceptable salt or ester thereof, to a crop between 30 and 90 days prior to harvest. In some aspects, a preferred ester of haloxyfop-P may be haloxyfop-P-methyl.

### DETAILED DESCRIPTION

Florpyrauxifen and florpyrauxifen-benzyl and their use are described in the Pesticide Manual 18^{th} Edition, 2016, British Crop Protection Council, and in J. Epp et al. Bioorg. Med. Chem., 2016, 24, 362-371. The compounds may be used for the post-emergent control of grass, broad-leaved and sedge weeds in rice; control of broad-leaved weeds in pastures.

Halauxifen and halauxifen-methyl and their use are described in the Pesticide Manual 18^{th} Edition, 2016, British Crop Protection Council, and in J. Epp et al. Bioorg. Med. Chem., 2016, 24, 362-371. The compounds may be used for control of broad-leaved weeds in winter and spring wheat, barley, triticale and forage brassicas; burndown application in no-till crops.

Haloxyfop-P and haloxyfop-P-methyl and their use are described in the Pesticide Manual 18^{th} Edition, 2016, British Crop Protection Council, and by M. C. Botte et al. (Proc. 15th Columa Conf., 1992, 1, 397). The compounds may be used for post-emergence control of annual and perennial grass weeds in sugar beets, fodder beets, oilseed rape, potatoes, leafy vegetables, onions, flax, sunflowers, soybeans, vines, strawberries and other crops, at 52-104 g ai/ha.

As used herein “DAA” represents days after application, for example by, the number of days elapsed since the application of various ripeners disclosed herein to a sugarcane crop.

As used herein “TRS” represents Total Recoverable Sugar-a measure of the quality of sugarcane, the capacity to be converted into sugar or alcohol.

As used herein “POL” or “% POL” represents the apparent percentage of sucrose contained in sugarcane juice (solution).

As used herein “Purity” or “% Purity” represents the characteristic Purity of the juice of sugarcane, which is directly related to the quality of the raw material and is influenced by mineral and vegetable impurities in the sugarcane at harvest.

As used herein “Fiber” or “% Fiber” refers to the efficiency of the extraction of the sugarcane, that is, the higher the sugarcane fiber, the lower the extraction efficiency.

As used herein “AR” refers to the amount of glucose and fructose present in sugarcane, which directly affect its purity, since they reflect a lower efficiency in the recovery of sucrose from the plant.

As used herein “BRIX” represents the weight percentage of soluble sugar (for example sucrose) in an aqueous solution. If the solution contains dissolved solids other than pure sucrose, then BRIX only approximates the dissolved solid content.

As used herein, agriculturally acceptable salts and esters refer to salts and esters of florpyrauxifen, halauxifen, and haloxyfop that exhibit herbicidal activity, or that are or can be converted in plants, water, or soil, to the corresponding acid. Exemplary agriculturally acceptable salts and esters are those that are or can be hydrolyzed, oxidized, metabolized, or otherwise converted, e.g., in plants, water, or soil, to corresponding acid which, depending upon the pH, may be in the dissociated or undissociated form.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The amount of florpyrauxifen, or an agriculturally acceptable salt or ester thereof applied to the crop is preferably from about 2 grams ai/ha to about 20 grams ai/ha, more preferably from about 2 grams ai/ha to about 12 grams ai/ha, and most preferably from about 2 grams ai/ha to about 8 grams ai/ha.

When florpyrauxifen, or an agriculturally acceptable salt or ester thereof is applied to a sugarcane crop it may be applied as the sole active ingredient or it may be applied in combination with one or more additional active ingredients. Preferred additional active ingredients include haloxyfop-P, sulfometuron, trinexapac, bispyribac, glyphosate, ethephon and agriculturally acceptable salts and esters thereof. A most preferred additional active ingredient is haloxyfop-P-methyl. Florpyrauxifen, or an agriculturally acceptable salt or ester thereof and the one or more additional active ingredients may be applied simultaneously or sequentially.

When florpyrauxifen is applied in combination with haloxyfop-P, the amount of florpyrauxifen applied is from about 2 grams ai/ha to about 20 grams ai/ha and the amount of haloxyfop-P applied is from about 10 grams ai/ha to about 40 grams ai/ha.

The amount of halauxifen, or an agriculturally salt or ester thereof, applied to the crop is preferably in the range of 2 grams ai/ha and 20 grams ai/ha, more preferably in the range of 2 grams ai/ha to 12 grams ai/ha, and most preferably in the range of 2 grams ai/ha to 8 grams ai/ha.

When halauxifen, or an agriculturally acceptable salt or ester thereof, is applied to a sugarcane crop it may be applied as the sole active ingredient or it may be applied in combination with one or more additional active ingredients. Preferred additional active ingredients include haloxyfop-P, sulfometuron, trinexapac, bispyribac, ethephon, glyphosate and agriculturally acceptable salts or esters thereof. A most preferred additional active ingredient is haloxyfop-P-methyl. Halauxifen, or an agriculturally acceptable salt or ester thereof, and the one or more additional active ingredients may be applied simultaneously or sequentially.

When halauxifen, or an agriculturally acceptable salt or ester thereof, is applied in combination with haloxyfop-P, or an agriculturally acceptable salt or ester thereof, the amount of halauxifen applied is in the range of 2 grams ai/ha and 20 grams ai/ha and the amount of haloxyfop-P applied is in the range of 10 grams ai/ha to 40 grams ai/ha.

Exemplary ripeners—florpyrauxifen, halauxifen, haloxyfop-P and agriculturally acceptable salts or esters thereof, and optionally one or more additional active ingredients—may be applied to plants that are from 9 months to 36 months old.

Ripeners are preferably applied from about 30 to about 90 days prior to harvest, more preferably applied from about 30 to about 60 days prior to harvest, most preferably applied from about 30 to about 45 days prior to harvest.

In some cases, when ripeners are applied, the sugarcane may be in the reproductive and ripening stage of growth.

In some instances, when ripeners are applied, the sugarcane may have green leaves and the plants should be healthy.

Various ripeners disclosed herein provide various economic benefits to sugarcane producers and sugarcane processors. For example, using 2020 figures, the average sugarcane yield is 90 ton/ha, with an average TRS of 120 kg TRS/ton raw sugarcane. The application of an effective ripener will add approximately 4 kg TRS/ton sugarcane, an approximately 3.33% increase in yield or approximately $50/ha.

### Experiments

### Florpyrauxifen-Benzyl, Haloxyfop-P-Methyl

Experiments were carried out in sugarcane in order to assess the performance of florpyrauxifen as a sugarcane ripener. The treatments were haloxyfop-P-methyl at 14.6; 27 and 54 g ai./ha adding mineral oil (0.5% v/v), florpyrauxifen-benzyl at 2.2 g ai./ha adding mineral oil (0.5% v/v), haloxyfop-P-methyl plus florpyrauxifen-benzyl at 27 plus 2.2 g ai./ha adding mineral oil (0.5% v/v), compared with Curavial (sulfometuron-methyl) at 15 g ai./ha adding mineral oil (0.1% v/v), Moddus (trinexapac-ethyl) at 250 g ai/ha and Untreated check. Trials were randomized as complete block design with four replications and plots with 4 by 10 m (40 m²). The products were diluted in water and a single application for each study (backpack sprayer) was performed delivering 50 L/ha output volume at the reproductive stage and from 30 to a maximum 60 days before harvest. After 14, 21, 30 and 45 days after application (DAA) samples were collected from treated areas and analyzed for % POL; % Purity; % Fiber and Total Recovery Sugar (TRS), measured in sugarcane juice after grinding and extracting the gross juice of stalks collected in central plots. Results observed at 30 DAA and 45 DAA are shown in Tables 1-4.

TABLE 1
Gain TRS (Kg/ton), Gain POL (%), Gain Purity (%), and
Gain Fiber (%) obtained from field studies in representative
sugar cane locations 30 days after application.

| | | | Gain | Gain | Gain |
|---|---|---|---|---|---|
| | Rate | Gain TRS | POL | Purity | Fiber |
| Treatment | (g ai/ha) | (kg/ton) | (%) | (%) | (%) |
| Haloxyfop-P- | 27 | 23.7 | 2.6 | 6.1 | 0.4 |
| methyl | | | | | |
| Florpyrauxifen- | 2.2 | 23.0 | 2.6 | 7.5 | 0.5 |
| benzyl | | | | | |
| Haloxyfop-P- | 27 + 2.2 | 21.0 | 2.4 | 7.2 | 0.7 |
| methyl + | | | | | |
| Florpyrauxifen- | | | | | |
| benzyl | | | | | |
| Sulfometuron | 15 | 21.3 | 2.4 | 6.5 | 0.6 |
| Trinexapac | 250 | 25.8 | 2.9 | 6.8 | 0.4 |
| Untreated | 0 | 25.2 | 2.8 | 7.2 | 0.6 |

TABLE 2
Gain TRS (Kg/ton), Gain POL (%), Gain Purity (%), and
Gain Fiber (%) obtained from field studies in representative
sugar cane locations 45 days after application.

| | | | Gain | Gain | Gain |
|---|---|---|---|---|---|
| | Rate | Gain TRS | POL | Purity | Fiber |
| Treatment | (g ai/ha) | (kg/ton) | (%) | (%) | (%) |
| Haloxyfop-P- | 27 | 39.9 | 4.4 | 10.3 | 0.1 |
| methyl | | | | | |
| Florpyrauxifen- | 2.2 | 44.0 | 4.9 | 10.3 | 1.5 |
| benzyl | | | | | |
| Haloxyfop-P- | 27 + 2.2 | 40.3 | 4.5 | 12.4 | 0.9 |
| methyl + | | | | | |
| Florpyrauxifen- | | | | | |
| benzyl | | | | | |
| Sulfometuron | 15 | 31.4 | 3.6 | 10.9 | 0.6 |
| Trinexapac | 250 | 34.9 | 3.8 | 5.8 | 0.8 |
| Untreated | 0 | 38.4 | 4.2 | 7.7 | 1.2 |

TABLE 3
Gain TRS (Kg/ton), Gain POL (%), Gain Purity (%), and
Gain Fiber (%) obtained from field studies in representative
sugar cane locations, single application 50 L/ha 60
days before harvest, results observed 30 DAA

| | | | Gain | Gain |
|---|---|---|---|---|
| | Rate | Gain TRS | POL | Purity |
| Treatment | (g ai/ha) | (kg/ton) | (%) | (%) |
| Haloxyfop-P-methyl | 14.5 | 27.8 | 3.3 | 13.0 |
| Haloxyfop-P-methyl | 50 | 23.7 | 2.8 | 8.1 |
| Haloxyfop-P-methyl | 100 | 28.6 | 3.2 | 7.2 |
| Florpyrauxifen-benzyl | 2.2 | 23.0 | 2.6 | 7.5 |
| Sulfometuron | 15 | 21.3 | 2.4 | 6.5 |
| Trinexapac | 250 | 25.0 | 2.9 | 6.8 |
| Untreated | | 25.2 | 2.8 | 7.2 |

TABLE 4
Gain TRS (Kg/ton), Gain POL (%), Gain Purity (%), and
Gain Fiber (%) obtained from field studies in representative
sugar cane locations, single application 50 L/ha 60
days before harvest, results observed 45 DAA

| | | | Gain | Gain |
|---|---|---|---|---|
| | Rate | Gain TRS | POL | Purity |
| Treatment | (g ai/ha) | (kg/ton) | (%) | (%) |
| Haloxyfop-P-methyl | 14.5 | 49.6 | 6.7 | 18.3 |
| Haloxyfop-P-methyl | 50 | 39.9 | 4.4 | 10.3 |
| Haloxyfop-P-methyl | 100 | 36.7 | 4.0 | 8.8 |
| Florpyrauxifen-benzyl | 2.2 | 44.0 | 4.9 | 10.3 |
| Sulfometuron | 15 | 31.4 | 3.6 | 10.9 |
| Trinexapac | 250 | 34.9 | 3.8 | 5.8 |
| Untreated | | 38.4 | 4.2 | 7.7 |

### Halauxifen-Methyl, Haloxyfop-P-Methyl

Experiments were carried out in sugarcane where halauxifen-methyl plus haloxyfop-P-methyl were compared to Moddus (trinexapac-ethyl) (250 gai/ha) and Curavial (sulfometuron-methyl) (15 gai/ha). Halauxifen-methyl plus haloxyfop-P-methyl and standards Moddus (trinexapac-ethyl) and Curavial (sulfometuron-methyl) were diluted in water and a single application for each study (backpack sprayer) was performed delivering 50 L of spray solution per ha at reproductive stage and from 30 days to a maximum 60 days before harvest. The activity of halauxifen-methyl plus haloxyfop-P-methyl as a ripener was verified via assessments (% POL; % Purity; % Fiber and TRS/Total Recovery Sugar) performed at 14, 21, 30, 45 and 60 days after application. The assessments were measured in sugarcane juice after grinding and extracting the gross juice of stalks collected in 2 meters at central plots. All analyses were submitted to sugarcane mill laboratory to complete the analyses. Results are shown in Table 5.

TABLE 5
Gain TRS (Kg/ton), Gain POL (%), Gain Purity (%) and Gain Fiber
(%) obtained from six field studies conducted in representative
sugar cane locations at 30 days after application.

| | | | Gain | Gain | Gain |
|---|---|---|---|---|---|
| | Rate | Gain TRS | POL | Purity | Fiber |
| Treatment | (g ai/ha) | (kg/ton) | (%) | (%) | (%) |
| Halauxifen-methyl | 2.16 | 25.4 | 3 | 7.1 | 0.5 |
| Haloxyfop-P-methyl + | 27 + 2.16 | 22.9 | 2.7 | 6.7 | 0.3 |
| Halauxifen-methy | | | | | |
| Haloxyfop-P-methyl | 27 | 24.7 | 2.9 | 6.6 | 0.7 |
| Sulfometuron | 15 | 15.9 | 1.9 | 1.9 | 0.1 |
| Trinexapac | 250 | 21.8 | 2.5 | 5.8 | 0.4 |
| Untreated | 0 | 23.4 | 2.7 | 6.8 | 0.5 |

### Haloxyfop-P-Methyl

In order to study the activity of Haloxyfop-P-methyl as possible herbicide for ratoon sugarcane control, field studies were carried out. Haloxyfop-P-methyl was tested at 124; 248; 373; 620 and 1240 g ai/ha plus mineral oil at 0.5% v/v and compared to key standard, as glyphosate (Glizmax Prime®) at 2160 g ae/ha. Trials were sprayed postemergence with 4 to 6 leaves or 50 to 60 cm of ratoon sugarcane regrowth and assessed percentage of control at 14; 30; 45 and 60 days after application (DAA). The results obtained proved that Haloxyfop-P-methyl displayed good ratoon sugarcane control, reaching more than 90% control at rates from 373 to 1240 g ai/ha at 30 DAA.

TABLE 6
Ratoon Sugarcane Control
Post application, 4 to 6 leaves, 50 to 60 cm, % Control

| | Rate g | 14 | 30 | 45 | 60 |
|---|---|---|---|---|---|
| Treatment | ai/ha | DAA | DAA | DAA | DAA |
| Haloxyfop-P-Methyl | 124 | 60.5 | 86.5 | 91.5 | 89.8 |
| Haloxyfop-P-Methyl | 248 | 67.2 | 88.7 | 92.0 | 90.8 |
| Haloxyfop-P-Methyl | 373 | 68.3 | 91.0 | 93.5 | 92.2 |
| Haloxyfop-P-Methyl | 620 | 71.8 | 94.7 | 95.2 | 94.8 |
| Haloxyfop-P-Methyl | 1240 | 74.5 | 95.2 | 96.3 | 95.5 |
| Glyphosate | 2160 | 84.5 | 89.3 | 95.7 | 96.0 |
| Untreated | 0 | 0 | 0 | 0 | 0 |

As shown in Tables 1-4, florpyrauxifen-benzyl ripening performance at 30 DAA was comparable to the standards trinexapac and sulfometuron, and at 45 DAA was unexpectedly superior to the standards.

In addition, the data in Tables 1-4 above demonstrate the performance of florpyrauxifen-benzyl plus haloxyfop-P-methyl are superior to the standards at 45 DAA.

As shown in Table 5, the data confirm the superior ripening performance of halauxifen-methyl plus haloxyfop-P-methyl. Halauxifen-methyl plus haloxyfop-P-methyl at 2.16 g ai/ha and 27 g ai/ha respectively, demonstrated excellent ripening performance in sugarcane—better than standard Sulfometuron-methyl—in most of the evaluated sugarcane technological characteristics at 30 days after application.

The control of ratoon sugarcane by haloxyfop-P-methyl is demonstrated in Table 6. The data demonstrate that haloxyfop-P-methyl may be useful for the control of ratoon sugarcane in glyphosate-resistant sugarcane varieties—where ratoon sugarcane control with glyphosate would not be feasible.

The nature, scope, utility, and effectiveness of various aspects of the present disclosure have been described and exemplified in the foregoing specification. These examples are not intended to be limiting.

1. A method for ripening a sugarcane crop comprising applying an effective amount of florpyrauxifen, or an agriculturally acceptable salt or ester thereof, to the crop from about 30 to about 90 days prior to harvest.

2. The method of claim 1, wherein florpyrauxifen, or an agriculturally acceptable salt or ester thereof, is florpyrauxifen-benzyl.

3. The method of claim 1, wherein the amount of florpyrauxifen is from about 2 grams ai/ha to about 20 grams ai/ha.

4. The method of claim 1, wherein the amount of florpyrauxifen is from about 2 grams ai/ha to about 12 grams ai/ha.

5. The method of claim 1, wherein the amount of florpyrauxifen is from about 2 grams ai/ha to about 8 grams ai/ha.

6. The method of claim 1, comprising an additional active ingredient.

7. The method of claim 6, wherein the additional active ingredient is selected from the group consisting of haloxyfop-P, sulfometuron, trinexapac, bispyribac, ethephon, glyphosate, and agriculturally acceptable salts or esters thereof.

8. The method of claim 6, wherein florpyrauxifen is florpyrauxifen-benzyl and wherein the additional active ingredient is haloxyfop-P-methyl.

9. The method of claim 8, wherein the amount of florpyrauxifen-benzyl is from about 2 grams ai/ha to about 20 grams ai/ha and the amount of haloxyfop-P-methyl is from about 10 grams ai/ha to about 40 grams ai/ha.

10. The method of claim 8, wherein the amount of florpyrauxifen-benzyl is from about 2 grams ai/ha to about 8 grams ai/ha and the amount of haloxyfop-P-methyl is from about 20 grams ai/ha to about 30 grams ai/ha.
